(19) United States
(12) Patent Application Publication
(10) Pub. No.: US 2011/0012872 A1
(43) Pub. Date: Jan. 20, 2011

(54) HAND-WRITING INPUT DEVICE AND HAND-WRITING INPUT SYSTEM

(75) Inventor: SHUN-FAN CHIANG, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/693,513

(22) Filed: Jan. 26, 2010

(30) Foreign Application Priority Data
Jul. 15, 2009 (CN) 200910304387.9

(51) Int. Cl. G06F 3/033

(52) U.S. Cl. 345/179

(57) ABSTRACT

A hand-writing input device includes a main body, a pressure sensing member, a tip portion, an amplifier and a light source. The pressure sensing member is received in the main body and configured for generating a voltage in response to a pressure applied thereto. The tip portion has a writing tip and an opposite head end. The tip portion extends through a distal end of the main body and contacts the pressure sensing member to apply the pressure to the pressure sensing member. The writing tip is exposed to the outside of the main body. The amplifier has an input terminal and an output terminal The pressure sensing member is electrically connected to the input terminal to provide a voltage thereto. The light source is fixed in the main body and electrically connected to the output terminal.

### BACKGROUND

1. Technical Field

The present disclosure relates to a hand-writing input device and a hand-writing input system.

2. Description of Related Art

With the development of information and communication technology, computers, mobile phones, personal digital assistants and other electronic devices are now widely used. Information input, such as character input, is a must have function for such electronic devices.

Information input modes include keyboard, voice, and handwriting input among others. A typical handwriting input device includes a writing panel and a stylus. An array of resistors or capacitors are installed in the writing panel. When the stylus touches the panel, resistances/capacitances of some resistors/capacitors are changed. Thus, a position of the stylus on the panel is sensed according to the change of the resistances/capacitances of the resistors/capacitors. A continuous movement of the stylus on the written panel can be sensed by continuously sensing the changes of the resistances/capacitances. Therefore, movement paths of the stylus are recorded, thus a hand-writing function is achieved.

This technology requires the resistors/capacitors in the panel to be highly sensitive to sense touch yet strong enough not to be damaged by prolonged use. Therefore, the hand-writing device should include expensive high quality resistors/capacitors.

Therefore, a device and system for hand-writing input are desirable to overcome the above-described shortcomings.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic, isometric view of an exemplary embodiment of a hand-writing input system, which includes a hand-writing input device.

FIG. 2 is a sectional view of the hand-writing input device of the hand-writing input system in FIG. 1.

FIG. 3 shows a circuit diagram of the hand-writing input device in FIG. 2.

FIG. 4 shows another embodiment of a circuit diagram of the hand-writing input device in FIG. 2.

### DETAILED DESCRIPTION

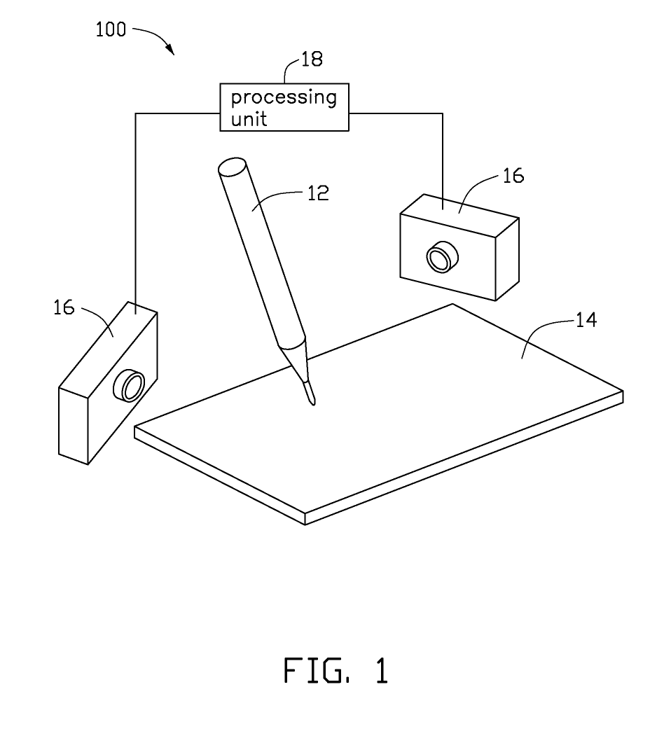

Referring to FIG. 1, a hand-writing input system 100 according to an exemplary embodiment includes a hand-writing input device 12, a writing board 14, an image capture device 16, and a processing unit 18.

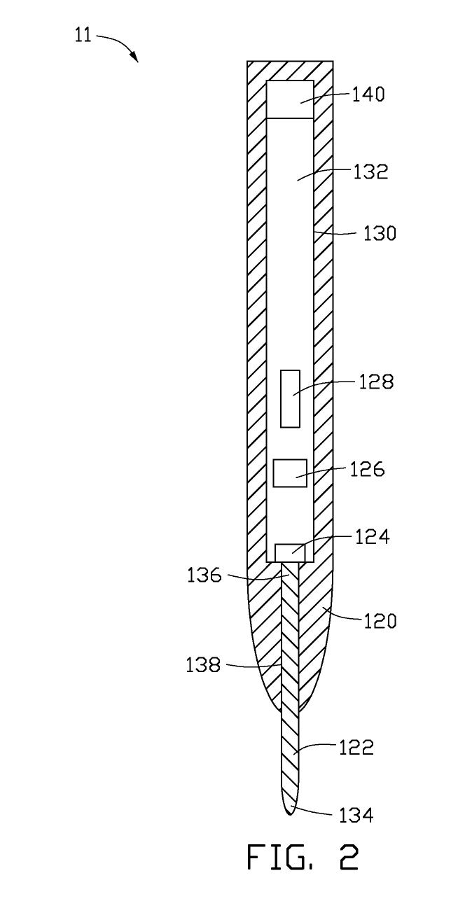

Referring also to FIG. 2, the hand-writing input device 12 includes a rod-shaped body 120, a tip portion 122, a pressure detecting member 124, an amplifier 126, and a light source 128. The rod-shaped body 120 defines a cavity 130 therein. A circuit board 132 is fixed in the cavity 130 of the rod-shaped body 120. The pressure detecting member 124, the amplifier 126 and the light source 128 are fixed to and electrically connected to the circuit board 132.

The tip portion 122 is rod-shaped, and has a writing tip 134 and an opposite head end 136. A through hole 138 is defined in one distal end of the rod-shaped body 120. The through hole 138 is in communication with the cavity 130 of the rod-shaped body 120. The tip portion 122 is slidably received in the through hole 138. The pressure sensing member 124 is arranged adjacent to an opening of the sliding hole 138 in the cavity 130 of the rod-shaped body 120. The head end 136 of the tip portion 122 contacts the pressure sensing member 124 for applying a pressure to the pressure sensing member 124 when the writing tip 134 of the tip portion 122 is pressed against the writing board 14. The writing tip 134 extends out of the distal end of the rod-shaped body 120. In use, the writing tip 134 is pressed to the writing board 14 which applies pressure to the pressure sensing member 124. The pressure sensing member 124 can output a voltage in response to the pressure. Different voltages correspond to different amounts of pressure. In this exemplary embodiment, the pressure sensing member 124 is comprised of a piezoelectric material.

The sidewall of the rod-shaped body 120 has a light-pervious portion such that an image of light emitted from the light source 128 can be captured by the image capture devices 16. In an alternative embodiment, the entire rod-shaped body 120 is made of a light-pervious material. In another alternative embodiment, the light source 128 extends through the sidewall of the rod-shaped body 120 to the outside of the rod-shaped body 120.

The two image capture devices 16 are arranged adjacent to the periphery of the writing board 14 for capturing images of the light emitted from the light source 128 and generating image signals associated therewith. In a preferred embodiment, the light source 128 is an infrared light source, and the image capture devices 16 are infrared light sensing devices. The processing unit 18 is electrically connected to the two image capture devices 16 for analyzing the image signals to determine intensity of the light and a movement track of the light source 128.

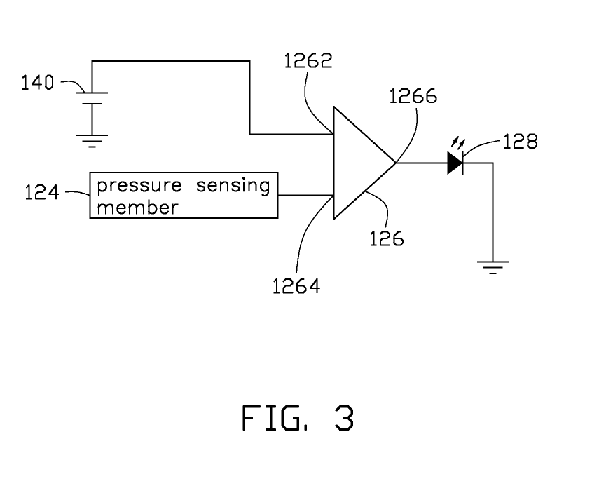

Referring to FIG. 3, a circuit diagram of the hand-writing input device 12 is shown. The amplifier 126 includes a first input terminal 1262, a second input terminal 1264, and an output terminal 1266. The first input terminal 1262 is electrically connected to a voltage source 140. The second input terminal 1264 is electrically connected to an output terminal of the pressure sensing member 124. The output terminal 1266 is electrically connected to the light source 128. In the exemplary embodiment, the light source 128 is a light emitting diode. Assuming that a voltage at the first input terminal 1262 is U1 and a voltage at the second input terminal 1264 is U2, an output voltage U0 at the output terminal 1266 can be expressed by a formula U0=f (U1−U2), wherein “f” is an amplification constant of the amplifier 126. In use, the voltage U1 is unchangeable and the voltage U2 varies in response to the different pressures applied to the pressure sensing member 124 by the writing tip 134. Thus, the voltage U0 is changed in response to the change of the voltage U2. The voltage U0 causes the light source 128 to emit light of a respective light intensity.

Referring to FIGS. 1 to 3, a hand-writing process using the hand-writing input system 100 is described in detail as follows. The rod-shaped body 120 is held, and the writing tip 134 of the tip portion 122 is pressed on the writing board 14. Then the hand-writing device 12 is moved on the writing board 14 while the writing tip 134 contacts the writing board 14. During movement of the hand-writing device 12, the light source 128 emits light. The two image capture devices 16 capture the light and generate image signals. The processing unit 18 analyzes the image signals from the image capture devices 16 to determine intensity of the light and movement tracks of the hand writing device 12 using algorithms known in the art. The processing unit 18 can be electrically connected to a display panel (not shown) to display the movement tracks of the image capture device 16. Different intensity of the light corresponds to different width of the tracks.

It is to be understood that the number of the image capture device 16 can be one or more than two, not limited to this embodiment. In this exemplary embodiment, the writing board 14 can be a wooden board, a metallic board, or a display panel.

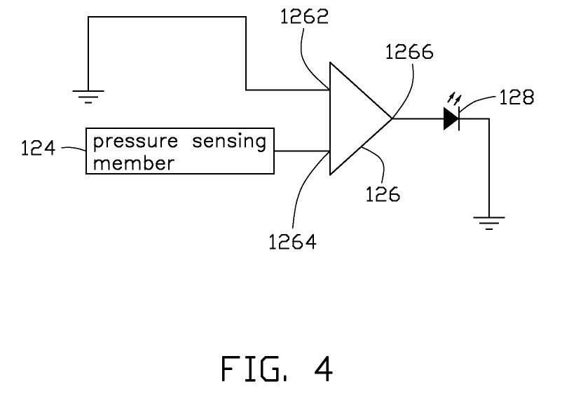

Referring to FIG. 4, in an alternative embodiment, the first input terminal 1262 can also be grounded. Here the output voltage U0 at the output terminal 1266 can be expressed by a formula U0=f(U2−0)=f*U2.

In this embodiment, the hand-writing system 100 utilizes image capture devices 16, a hand-writing device 12, and a processing unit 18 to realize the hand-writing function. Thus, there is no need to use expensive resistors/capacitors, which can reduce cost of manufacture.

It is to be understood that the above-described embodiment is intended to illustrate rather than limit the embodiments. Variations may be made to the embodiment without departing from the spirit of the disclosure as claimed. The above-described embodiments are intended to illustrate the scope of the disclosure and not restrict the scope of the embodiments.

What is claimed is:

1. A hand-writing input device, comprising:
a main body;
a pressure sensing member received in the main body, the pressure sensing member configured for generating a voltage in response to a pressure applied thereto;
a tip portion having a writing tip and an opposite head end, the tip portion extending through a distal end of the main body and contacting the pressure sensing member to apply the pressure to the pressure sensing member, the writing tip exposed to the outside of the main body;
an amplifier fixed in the main body, the amplifier having a first input terminal, a second input terminal, and an output terminal, the pressure sensing member electrically connected to the first input terminal to provide a first voltage thereto; and
a light source fixed in the main body and configured for emitting light to the outside of the main body, the light source electrically connected with the output terminal of the amplifier.

2. The hand-writing input device of claim 1, wherein the main body is rod-shaped.

3. The hand-writing input device of claim 1, wherein the pressure sensing member is comprised of a piezoelectric material.

4. The hand-writing input device of claim 1, wherein the tip portion is rod-shaped.

5. The hand-writing input device of claim 1, further comprising a voltage source wherein the second input terminal is electrically connected with the voltage source.

6. The hand-writing input device of claim 1, wherein the second input terminal is grounded.

7. The hand-writing input device of claim 1, wherein the light source is an infrared light source.

8. A hand-writing input system, comprising:
a hand-writing input device comprising:
a main body;
a pressure sensing member received in the main body, the pressure sensing member configured for generating a voltage in response to a pressure applied thereto;
a tip portion having a writing tip and an opposite head end, the head end received in the main body and contacting the pressure sensing member to apply the pressure to the pressure sensing member, the writing tip exposed to an outside of the main body;
an amplifier fixed in the main body, the amplifier having a first input terminal, a second input terminal, and an output terminal, the pressure sensing member electrically connected to the first input terminal to provide a first voltage thereto; and
a light source fixed in the main body and configured for emitting light to the outside of the main body, the light source electrically connected with the output terminal of the amplifier;
a writing board, the hand-writing input device configured for writing on the writing board;
an image capture device for capturing images of the light and generating signals associated therewith; and
a processing unit for analyzing the signals to obtain intensity of the light and movement track of the hand-writing input device.

9. The hand-writing input system of claim 8, wherein the main body is rod-shaped.

10. The hand-writing input system of claim 8, wherein the pressure sensing member is comprised of a piezoelectric material.

11. The hand-writing input system of claim 8, wherein the tip portion is rod-shaped.

12. The hand-writing input system of claim 8, wherein the second input terminal is electrically connected with a voltage source.

13. The hand-writing input system of claim 8, wherein the second input terminal is grounded.

14. The hand-writing input system of claim 8, wherein the light source is an infrared light source, and the image capture device is an infrared light sensing device.
